(19) United States
(12) Patent Application Publication
(10) Pub. No.: US 2019/0214193 A1
(43) Pub. Date: Jul. 11, 2019

(54) WIRE OUTLET NOZZLE ARRANGEMENT

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 16/218,099

(22) Filed: Dec. 12, 2018

(30) Foreign Application Priority Data
Jan. 11, 2018 (EP) 18151156.9

(51) Int. Cl. H01F 41/082; H02K 15/04; H01F 41/096

(52) U.S. Cl. CPC H01F 41/082; H01F 41/096; H02K 15/0478

(57) ABSTRACT

A wire outlet nozzle arrangement includes one or multiple wire outlet nozzles situated parallel to one another, each or all of which guides or guide a winding wire in a wire feed direction. The wire outlet nozzle or nozzles includes or include an outlet opening, through which the winding wire guided in the wire outlet nozzle exits the respective wire outlet nozzle. The wire outlet nozzle or nozzles is or are mounted so as to rotate about a rotation axis parallel to the wire feed direction.

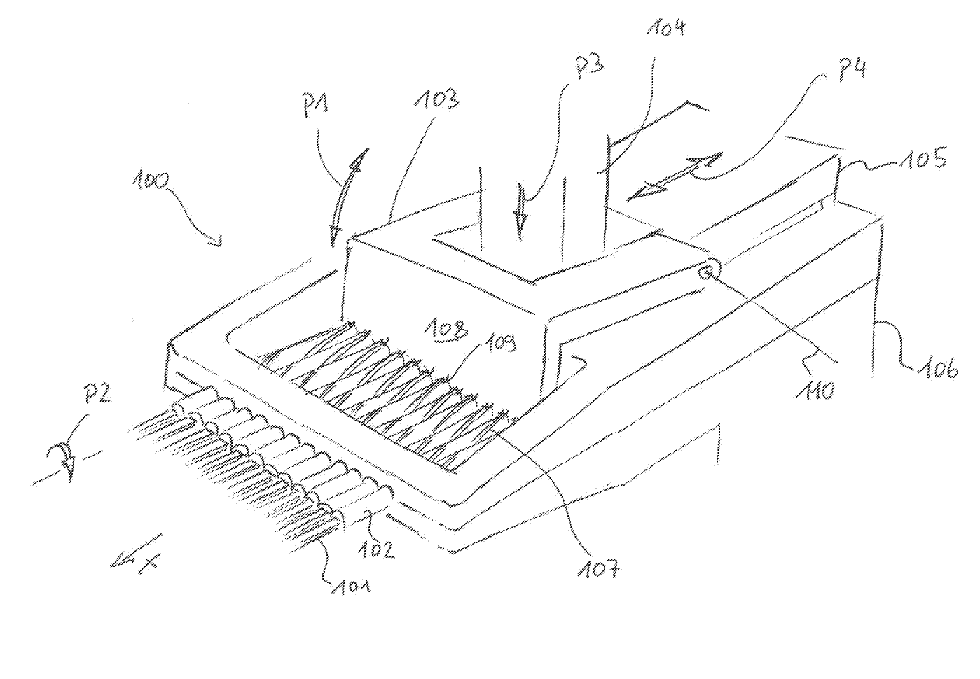

### CROSS REFERENCE TO RELATED APPLICATIONS

This patent application claims priority on and the benefit of European Patent Application No. 18151156.9 having a filing date of 11 Jan. 2018.

### BACKGROUND OF THE INVENTION

### Technical Field

The invention relates to a wire outlet nozzle arrangement, including one or multiple wire outlet nozzles situated parallel to one another, each or all of which guides or guide a winding wire in a wire feed direction, wherein the wire outlet nozzle or nozzles includes or include an outlet opening, through which the winding wire guided in the wire outlet nozzles exits the respective wire outlet nozzle.

### Prior Art

In winding methods, in particular in the production of wave windings, a winding wire or a plurality of parallel winding wires is fed from wire outlet nozzles to a body to be wound. The orientation of the wire may be a decisive factor if, rather than rounded wires, i.e. wires having a circular cross section, wires having a non-rotationally symmetrical, cross sectional geometry are to be wound. Flat wires, i.e. wires having a rectangular cross section are used, for example in waving winding methods.

Winding wires having a non-rotationally symmetrical geometry necessarily result in wider winding heads, since there the wire is bent, which necessarily means that corresponding winding head geometries occupy a larger space than is the case with round wires. Normally, the attempt is made in a subsequent step, once the waving winding is produced, to press the winding heads as flat as possible or to reshape them, however, this necessarily means that the wire must be machined or pressed at this point with a tool, such that the wire surface may be damaged as a result of this process. It is therefore desirable to optimize the geometry of the winding head already during the winding of a wave winding, so that to the extent possible, head sections formed by an entire number of windings do not also impede one another.

### BRIEF SUMMARY OF THE INVENTION

The object of the present therefore is to specify a wire outlet nozzle arrangement of the aforementioned kind and a wave winding device, with the aid of which the design of winding heads may be influenced already during the wire feed.

This object is achieved by a wire outlet nozzle arrangement, including one or multiple wire outlet nozzles situated parallel to one another, each or all of which guides or guide a winding wire in a wire feed direction, wherein the wire outlet nozzle or nozzles includes or include an outlet opening, through which the winding wire guided in the wire outlet nozzles exits the respective wire outlet nozzle, characterized in that the wire outlet nozzle or nozzles is or are mounted so as to rotate about a rotation axis parallel to the wire feed direction and by a wave winding device including a wire outlet nozzle arrangement as disclosed herein. Advantageous embodiments are found in the dependent claims.

According to the invention, it is provided that individual wire outlet nozzles are to be designed so as to rotate. In this way, wires having a non-rotationally symmetrical geometry may be placed on a winding head, in particular, a shaping core, already during the winding process, so that the wire occupies a preferred position when bent. The wire outlet nozzle arrangement according to the invention also includes one wire outlet nozzle or a plurality of wire outlet nozzles situated parallel to one another, each or all of which guides or guide a winding wire in a wire feed device. The wire outlet nozzle or nozzles in this configuration includes or include an outlet opening, through which the winding wire guided in the wire outlet nozzle exits the respective wire outlet nozzle. The wire outlet nozzle or nozzles is or are each mounted so as to rotate about a rotation axis parallel to the wire feed direction.

This arrangement is particularly suitable for the use of flat wires. For this purpose, it may be provided, in particular, that the outlet openings of the wire outlet nozzles have a rectangular cross section, wherein the winding wire also has a rectangular cross section.

There are multiple possibilities for rotating the nozzles. One embodiment of the wire outlet nozzle arrangement, in particular, which includes a manipulation device that is movable in or opposite the wire feed direction, has proven advantageous. This manipulation device, through its movement, is capable of turning the wire outlet nozzles about a rotation axis parallel to the wire feed direction. In this way, it is possible to convert a linear movement of the manipulation device to a rotational movement of the nozzles. The manipulation device may, in particular, be designed as a component that may be positioned on the nozzles, i.e., it may be engaged or disengaged from the wire outlet nozzles, for example, by detaching the engaging sections from, or bringing the engaging sections into engagement with, the engaging contours on the winding nozzles.

In this way, it is possible not only to achieve a reversible turning of the winding nozzles by sliding the manipulation device back and forth, but to also generate a turning of the nozzles continuously in one direction, should this become necessary as a result of the desired manufacturing process. For this purpose, the manipulation device is engaged with the nozzles, then moved in one direction, subsequently disengaged from the nozzles, after which it is moved back in the opposite direction, then re-engaged with the nozzles. This sequence is repeated for a continuous rotation in one direction if it should be necessary. The reversible turning, i.e., the rotation at a particular angle and back again, in which the manipulation device remains engaged with the winding nozzles the entire time, may of course be combined with the rotation in merely one direction beyond 180° in conjunction with a winding process.

In the simplest case, the manipulation device may also include a swiveling slider mounted for slidable movement in the wire outlet nozzle arrangement and for positioning on the nozzles, wherein the slider may also be positioned differently than by swiveling. For example, by mounting it for slidable movement in a direction perpendicular to the wire feed direction X.

According to one particularly preferred embodiment, it is provided that the outside of each of the wire outlet nozzles includes an engagement contour extended helically around the outside of the wire outlet nozzles. The manipulation device may then interact in this engagement contour or with this engagement contour to thereby achieve a rotation of the nozzles, similar, for example, to the way in which a drill rotates.

It is preferably provided in this case that the engagement contour of the wire outlet nozzles comprises a groove. In this way, the manipulation device may then engage in this helical groove with corresponding projections and in this way, through linear movement, cause the nozzles to rotate. In general, it is provided that the manipulation device includes an engagement section, which is designed to engage with the respective engagement contours of the respective wire outlet nozzle. Specifically, the engagement sections may include corresponding engagement projections or engagement recesses. It may prove advantageous during the course of the process, in particular, if the orientation of the wire cross section does not have to be altered during the winding process, if the rotational position of the nozzles can be held in particular angular positions. For this purpose, it is provided, in particular, according to one advantageous embodiment of the present invention that the wire outlet nozzle arrangement according to the invention includes a locking device, which is designed to fix the wire outlet nozzle in a previously set rotational position.

As mentioned at the outset, the wire outlet nozzle arrangement according to the invention is suitable, in particular, for use in a wave winding device.

### BRIEF DESCRIPTION OF THE DRAWING

The invention is explained in greater detail below with reference to the character FIGURE, which schematically shows a perspective view of a sketch of a wire outlet nozzle arrangement according to the invention.

### DETAILED DESCRIPTION OF PREFERRED EMBODIMENTS

One embodiment according to the invention may contain merely some of the components depicted in the FIGURE. Although a plurality of wire outlet nozzles is shown in the following exemplary embodiment, the invention theoretically also functions with merely one nozzle. Thus, insofar as the following description relates to a plurality of nozzles, it accordingly also applies for merely one nozzle.

The wire outlet nozzle arrangement 100 according to the invention in the example shown includes a housing or a holding frame 106, in which the wire outlet nozzles 102 are mounted. Winding wires 101 are guided through the wire outlet nozzles 102, which are then fed in a wire feed direction X to a winding body (not shown). The unit depicted in the example shown includes a plurality of wire outlet nozzles 102, which are situated parallel to one another with their longitudinal axis oriented in feed direction X. According to the invention, the nozzles 102 include engagement contours 107 extended helically around their outside, which—as in the example shown—may be designed as grooves, however, they may also be differently designed, for example as projections. The design of the grooves has the advantage that the spacing of the nozzles may be minimal. The engagement contours 107 serve to interact with a manipulation device 103, the manipulation of which results in the rotation of the nozzles 102 about an axis P2. Accordingly, the manipulation device 103 includes for such purpose engagement sections 109 situated on the front side 108 of the manipulation device 103 and are designed to engage with the corresponding engagement contours 107 of the wire outlet nozzles 102. The engagement contours 107 in the example shown extend helically around the outside of the nozzles 102 so that the movement of the manipulation device in and opposite the feed direction X results in the rotation of all nozzles 102 synchronously about the axis P2.

In the example shown, the manipulation device 103 may be positioned opposite the nozzles 102, i.e., it can be engaged and disengaged with the nozzles 102 in the area of the engagement sections 109, respectively, in the area of the engagement contours 107. The positioning may be accomplished in that the manipulation device 103 may be moved toward the nozzles 102 in a direction perpendicular to the feed direction X and removed from the former again. In the example shown, it is provided that the manipulation device is a pivotable component, which may be swiveled about a pivot axis 110 in the arrow direction P1. The position of the manipulation device 103 may be fixed via a fixing section 104, which can be moved in the direction of arrow P3, for example, perpendicular to the feed direction X. The manipulation device 103 is preferably movable in feed direction X and opposite the feed direction X (indicated by the arrow P4). For this purpose, it may be attached to a carriage 105, on the other hand it is, as in the example shown, also designed for pivotal movement about the pivot axis 110. The carriage 105 is mounted on the housing 106 so as to move in the arrow direction P4 parallel to the feed direction X.

What is claimed is:

1. A wire outlet nozzle arrangement (100), comprising one or multiple wire outlet nozzles (102) situated parallel to one another, each or all of which guides or guide a winding wire (101) in a wire feed direction (X), wherein the wire outlet nozzle or nozzles (102) includes or include an outlet opening, through which the winding wire (101) guided in the wire outlet nozzles (102) exits the respective wire outlet nozzle (102),
wherein
the wire outlet nozzle or nozzles (102) is or are mounted so as to rotate about a rotation axis (P2) parallel to the wire feed direction (X).

2. The wire outlet nozzle arrangement (100) according to claim 1,
wherein
the outlet openings of the wire outlet nozzles (102) have a rectangular cross section, wherein the winding wire (101) also has a rectangular cross section.

3. The wire outlet nozzle arrangement (100) according to claim 1,
further comprising
a manipulation device (103) movable in or opposite the wire feed direction (X), which is configured so that, through its movement, the wire outlet nozzles (102) are turned about the rotation axis (P2) parallel to the wire feed axis (X).

4. The wire outlet nozzle arrangement (100) according to claim 1,
wherein
the outside of each of the wire outlet nozzles (102) includes an engagement contour (107) on its outside extended helically around the outside of the wire outlet nozzle (102).

5. The wire outlet nozzle arrangement (100) according to claim 4,
wherein
the engagement contour (107) comprises a groove.

6. The wire outlet nozzle arrangement (100) according to claim 3,
wherein
the outside of each of the wire outlet nozzles (102) includes an engagement contour (107) on its outside extended helically around the outside of the wire outlet nozzle (102), and
the manipulation device (103) includes an engagement section (108) for engaging with the respective engagement contours (107) of the respective wire outlet nozzle (102), in particular, includes corresponding engagement projections or engagement recesses (109).

7. The wire outlet nozzle arrangement (100) according to claim 1,
further comprising
a locking device (104), which is designed to fix the wire outlet nozzles (102) in a previously set rotational position.

8. The wire outlet nozzle arrangement (100) according to claim 3,
wherein
the manipulation device (103) is engagable or disengagable with the wire outlet nozzles (102).

9. A wave winding device, including a wire outlet nozzle arrangement (100) comprising one or multiple wire outlet nozzles (102) situated parallel to one another, each or all of which guides or guide a winding wire (101) in a wire feed direction (X), wherein the wire outlet nozzle or nozzles (102) includes or include an outlet opening, through which the winding wire (101) guided in the wire outlet nozzles (102) exits the respective wire outlet nozzle (102),
wherein
the wire outlet nozzle or nozzles (102) is or are mounted so as to rotate about a rotation axis (P2) parallel to the wire feed direction (X).

10. The wave winding device according to claim 9,
wherein
the outlet openings of the wire outlet nozzles (102) have a rectangular cross section, wherein the winding wire (101) also has a rectangular cross section.

11. The wave winding device according to claim 9, wherein the wire outlet nozzle arrangement (100),
further comprises
a manipulation device (103) movable in or opposite the wire feed direction (X), which is configured so that, through its movement, the wire outlet nozzles (102) are turned about the rotation axis (P2) parallel to the wire feed axis (X).

12. The wave winding device according to claim 9,
wherein
the outside of each of the wire outlet nozzles (102) includes an engagement contour (107) on its outside extended helically around the outside of the wire outlet nozzle (102).

13. The wave winding device according to claim 12,
wherein
the engagement contour (107) comprises a groove.

14. The wave winding device according to claim 11,
wherein
the outside of each of the wire outlet nozzles (102) includes an engagement contour (107) on its outside extended helically around the outside of the wire outlet nozzle (102), and
the manipulation device (103) includes an engagement section (108) for engaging with the respective engagement contours (107) of the respective wire outlet nozzle (102), in particular, includes corresponding engagement projections or engagement recesses (109).

15. The wave winding device according to claim 9, wherein the wire outlet nozzle arrangement (100),
further comprises
a locking device (104), which is designed to fix the wire outlet nozzles (102) in a previously set rotational position.

16. The wave winding device according to claim 11,
wherein
the manipulation device (103) is engagable or disengagable with the wire outlet nozzles (102).
